(19) United States
(12) Patent Application Publication
(10) Pub. No.: US 2024/0220769 A1
(43) Pub. Date: Jul. 4, 2024

(54) MACHINE LEARNING PROCESSING CIRCUIT AND INFORMATION PROCESSING APPARATUS

(71) Applicant: THE UNIVERSITY OF TOKYO, Tokyo (JP)

(72) Inventors: Atsutake KOSUGE, Tokyo (JP); Tadahiro KURODA, Tokyo (JP)

(73) Assignee: THE UNIVERSITY OF TOKYO, Tokyo (JP)

(21) Appl. No.: 18/288,889

(22) PCT Filed: Apr. 27, 2022
(86) PCT No.: PCT/JP2022/019044

§ 371 Date: Oct. 30, 2023

(30) Foreign Application Priority Data
Apr. 28, 2021 (JP) 2021-076487

(51) Int. Cl. G06N 3/04; G06N 3/092

(52) U.S. Cl. CPC G06N 3/04; G06N 3/092

(57) ABSTRACT

A machine learning processing circuit including a plurality of neuron cell circuit. Each of the plurality of neuron cell circuit includes an input unit that receives a plurality of input signals, an adder unit that adds the input signals received by the input unit, and a storage unit that holds output results of a non-linear function corresponding to input values, uses an output signal output by the adder unit, as an input value, and outputs an output result of the non-linear function corresponding to the input value.

### TECHNICAL FIELD

The present invention relates to a machine learning processing circuit and an information processing apparatus.

### BACKGROUND ART

In recent years, a plurality of circuits that simulate neurons are used in a general neural network circuit, and each of the circuits performs an operation of multiplying a plurality of input signals by corresponding weights, accumulating results of multiplying the input signals by the weights, using an activation function to non-linearly convert the results, and outputting the results.

In this case, the cost of storing and reading the weights, performing a multiply and accumulation calculation of the input signals, and the like is high in the machine learning of the weights and the connectivity between the circuits simulating the neurons, and various methods for efficient machine learning are studied (NPL 1).

### CITATION LIST

### Non Patent Literature

[NPL 1]
Song Han, et al., Learning both Weights and Connections for Efficient Neural Networks, Advances in Neural Information Processing Systems, Vol. 28, 2015 (arXiv: 1506.02626)

### SUMMARY

### Technical Problem

However, the multiply and accumulation calculation in addition to the writing and reading of the weight information cannot be avoided after all in the conventional neural network circuit, and hence, there is a problem that the energy efficiency cannot sufficiently be improved.

The present invention has been made in view of the circumstances, and an object of the present invention is to provide a machine learning processing circuit and an information processing apparatus that can improve the energy efficiency.

### Solution to Problem

In order to solve the problem of the conventional example, according to an aspect of the present invention, there is provided a machine learning processing circuit including a plurality of neuron cell circuit. Each of the plurality of neuron cell circuit includes an input unit that receives a plurality of input signals, an adder unit that adds the input signals received by the input unit, and a storage unit that holds output results of a non-linear function corresponding to input values, uses an output signal output by the adder unit, as an input value, and outputs an output result of the non-linear function corresponding to the input value.

### Advantageous Effect of Invention

According to the present invention, the machine learning processing circuit is realized by the addition and one memory reading instead of a large number of memory readings, the multiply and accumulation calculation, and the like, and the energy efficiency can thus be improved.

### BRIEF DESCRIPTION OF DRAWINGS

FIG. 1 is a block diagram illustrating a configuration example of an information processing apparatus according to an example of an embodiment of the present invention.

FIG. 2 is a schematic wiring diagram illustrating a schematic configuration of a neuron cell integrated circuit according to an example of the embodiment of the present invention.

FIG. 3 is a block diagram illustrating a configuration example of a neuron cell circuit according to an example of the embodiment of the present invention.

FIG. 4 is a block diagram illustrating a configuration example of a neuron cell circuit according to another example of the embodiment of the present invention.

FIG. 5 is a block diagram illustrating a configuration example of a neuron cell circuit according to another example of the embodiment of the present invention.

FIG. 6 is a block diagram illustrating a configuration example of a neuron cell circuit according to still another example of the embodiment of the present invention.

FIG. 7 is a block diagram illustrating a configuration example of the neuron cell circuit according to yet another example of the embodiment of the present invention.

FIG. 8 is a schematic wiring diagram illustrating a schematic configuration of the neuron cell integrated circuit according to another example of the embodiment of the present invention.

FIG. 9 is a schematic wiring diagram illustrating a schematic configuration of a shift register circuit unit according to another example of the embodiment of the present invention.

FIG. 10 is an explanatory diagram illustrating a processing example of image data processed by the information processing apparatus according to another example of the embodiment of the present invention.

FIG. 11 is a schematic wiring diagram illustrating a schematic configuration of the neuron cell integrated circuit according to yet another example of the embodiment of the present invention.

FIG. 12 is a schematic wiring diagram illustrating a configuration example of a link circuit according to an example of the embodiment of the present invention.

FIG. 13A and FIG. 13B depict schematic wiring diagrams illustrating examples of a switch with a storage element used in the embodiment of the present invention.

FIG. 14 is an explanatory diagram illustrating a mode of integration of the neuron cell circuits according to an example of the embodiment of the present invention.

### DESCRIPTION OF EMBODIMENT

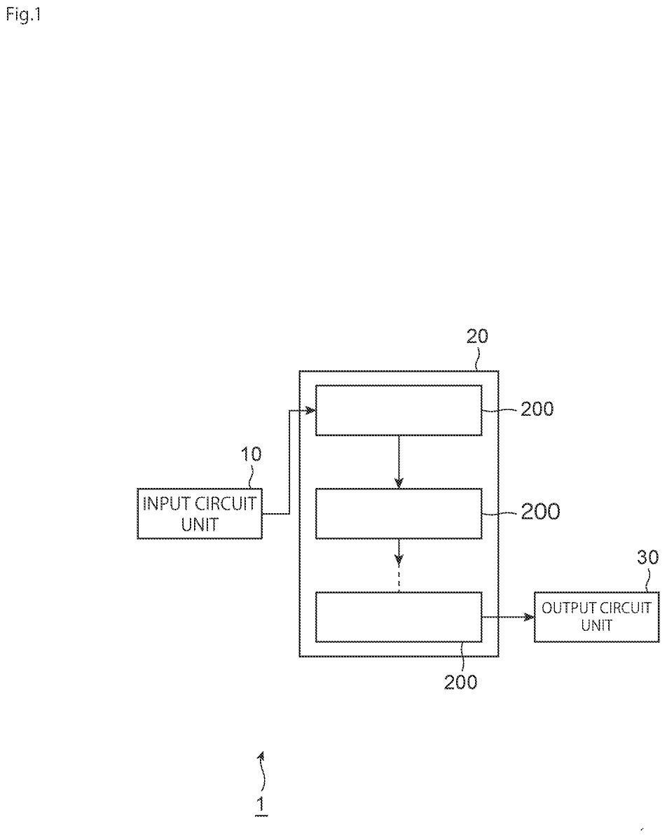

An embodiment of the present invention will be described with reference to the drawings. An information processing apparatus 1 according to the embodiment of the present invention includes an input circuit unit 10, at least one machine learning processing circuit 20, and an output circuit unit 30 as illustrated in FIG. 1.

The input circuit unit 10 receives data from outside and outputs the data to the machine learning processing circuit 20. The received data here includes a plurality of pieces of (for example, K pieces of, where K is an integer with K>1) N bits of (N is a natural number equal to or greater than 1) data.

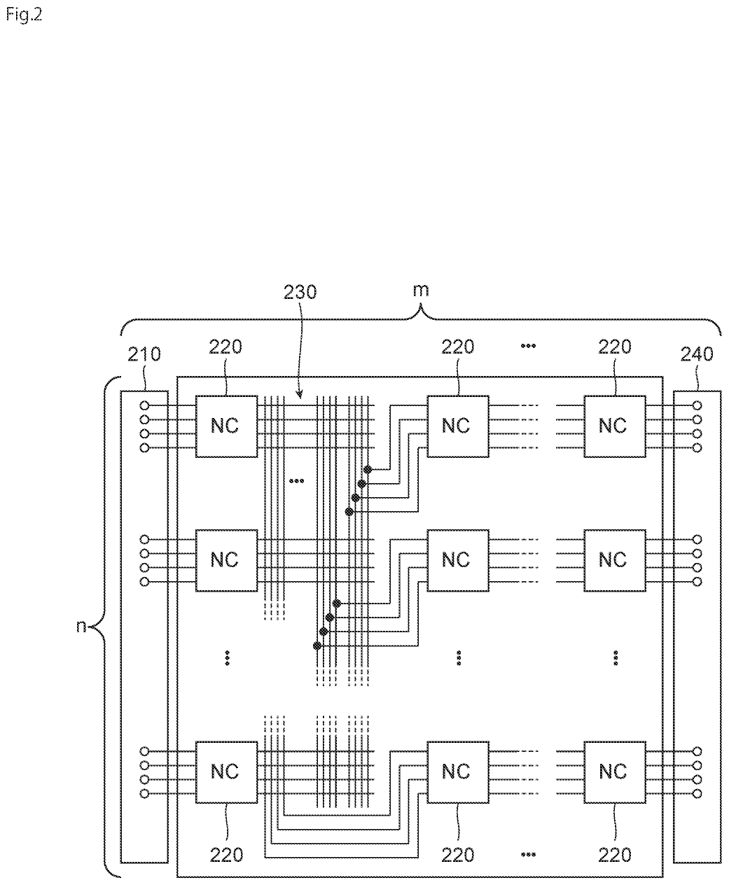

The machine learning processing circuit 20 includes at least one neuron cell integrated circuit 200. The neuron cell integrated circuit 200 here includes an input-side circuit 210, a plurality of neuron cell circuit 220 (abbreviated as NC in FIG. 2), a link circuit 230, and an output-side circuit 240 as illustrated in FIG. 2.

The input-side circuit 210 receives K pieces of N bits of data (K×N bits of data in total) output by the input circuit unit 10 or another neuron cell integrated circuit 200 (neuron cell integrated circuit 200 other than the neuron cell integrated circuit 200 including this input-side circuit 210 itself).

The input-side circuit 210 outputs the received data to at least a part of a plurality of neuron cell circuit 220 that are present in the same neuron cell integrated circuit 200. Note that the input-side circuit 210 in this case does not have to output the K pieces of data to each of the neuron cell circuits 220 determined to be destinations of the data, and the input-side circuit 210 may output, to a corresponding one of the neuron cell circuits 220, data selected for each destination from among the K pieces of data.

For example, it is assumed that there are four neuron cell circuits 220 set by the input-side circuit 210 as destinations of the data, and each of them will be referred to as a first neuron cell circuit 220a, a second neuron cell circuit 220b, In addition, K=16 is set. In this case, the input-side circuit 210 may operate as follows. That is, in an example of the present embodiment, the input-side circuit 210 outputs first to fourth N bits of data (4×N bits of data in total) to the first neuron cell circuit 220a among the four neuron cell circuits 220a, 220b, 220c, and 220d. In addition, the input-side circuit 210 outputs fifth to eighth N bits of data to the second neuron cell circuit 220b, and so forth. In this way, the input-side circuit 210 may divide the received data into pieces of data each including four N bits of data and output the data to a corresponding one of the neuron cell circuits 220.

In the following description, the neuron cell circuits 220 that directly receive the input of data from the input-side circuit 210 in this way will be referred to as input-end circuits, and the neuron cell circuits 220 that directly output data to the output-side circuit 240 described later (that is, the neuron cell circuits 220 that output data to be output to the outside of the neuron cell integrated circuit 200) will be referred to as output-end circuits. Further, the neuron cell circuits 220 excluding the output-end circuits among the neuron cell circuits 220 included in the neuron cell integrated circuit 200 (that is, the neuron cell circuits 220 whose output may be output to other neuron cell circuits 220) will be referred to as intermediate circuits.

The neuron cell circuit 220 includes an input unit 2201 that receives a plurality of pieces of data, an adder unit 2202 that accumulates the data received by the input unit 2201, and a storage unit 2203.

Specifically, the input unit 2201 includes K input ports and receives input data through each input port. Note that the input data does not have to be input to all the K input ports, and the input data may not be input to some of the input ports. In this case, the input port with no data input thereto is connected to, for example, ground (GND) (wiring with potential at ground level), and data input from this input port indicates “0.”

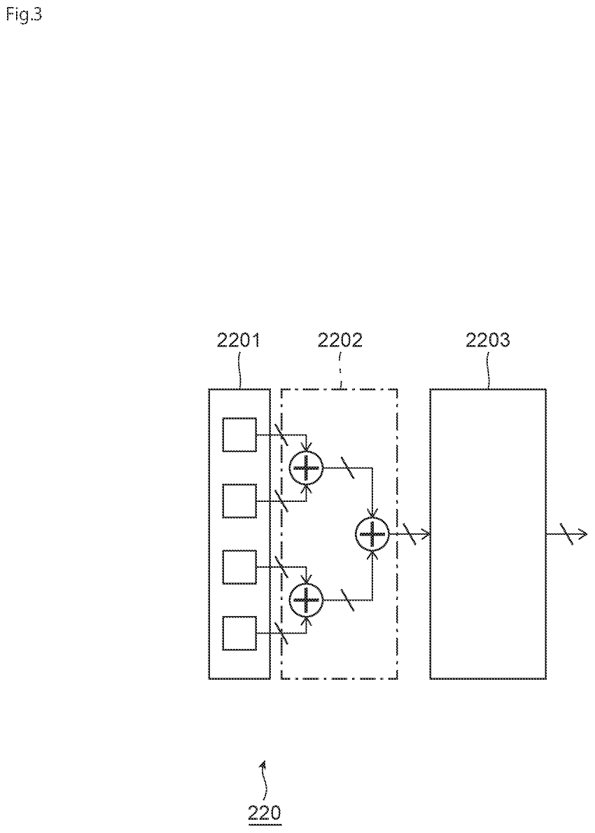

The adder unit 2202 accumulates the input data input to the K input ports of the input unit 2201. The adder unit 2202 may include, for example, a combination of a plurality of two-input adders to execute the accumulation, as illustrated in FIG. 3, or may include a K-input adder.

In addition, the storage unit 2203 includes a memory element. Here, the memory element may be, for example, a non-volatile memory element such as a read-only memory (ROM), or may be a non-volatile, rewritable resistive random-access memory (ReRAM). Further, a volatile static RAM (SRAM) may be used.

A predetermined function value is stored in the storage unit 2303. Specifically, a value of f (a·Δq) that is a value calculated by using a predetermined function f is stored (as N bits of value) in a memory address a of the storage unit 2303. Here, Δq is obtained by Δq=(xmax−xmin)/(Vmax−Vmin), where Vmax is a maximum value that can be output by the adder unit 2202, Vmin is a maximum value, and xmin and xmax (where xmin<xmax) are domains of the function f, for example. However, the calculation of Δq is not limited to this, and another calculation method may be used to determine Δq as long as the values of the function f are output when input values from Vmin to Vmax defining the range described above are input. Alternatively, the domains xmin and xmax of the function f may be set such that Δq=1 holds. In this way, the output results of the predetermined function corresponding to the input values are held in the storage unit 2203.

The storage unit 2203 sets the result of the accumulation output by the adder unit 2202, as address information, and outputs data indicating the value stored in the memory address corresponding to the address information.

In the example of the present embodiment, the function for calculating the values stored in the storage unit 2203 is a non-linear function and is a function selected from, for example, a sigmoid function:

$$y = \frac{1}{1 + {e}^{- ax}} \qquad [ Math . 1 ]$$

a ReLU function, a Step function:

$$t = \begin{matrix}0 & ( 0 < x ) \\ 1 & ( 0 \geq x )\end{matrix} \qquad [ Math . 2 ]$$

a Swish function:

$$y = \frac{bx}{1 + {e}^{- ax}} \qquad [ Math . 3 ]$$

an absolute value function, a Gaussian function, tan h, a sine function, a cosine function, and the like. In addition, the storage units 2203 of the neuron cell circuits 220 that are present in one neuron cell integrated circuit 200 may store values calculated by non-linear functions different from each other. Moreover, the storage units 2203 may store values calculated by the same type of non-linear function with parameters different from each other.

Specifically, even if the same sigmoid function

$$y = \frac{1}{1 + {e}^{- ax}} \qquad [ Math . 1 ]$$

is used, the value of the sigmoid function where a=3 may be stored in the storage unit 2203 of one neuron cell circuit 220, and the value of the sigmoid function where a=0.3 may be stored in the storage unit 2203 of another neuron cell circuit 220 in the same neuron cell integrated circuit 200.

The data of N bits of value output by the storage unit 2203 is output to the outside of the neuron cell circuit 220 including this storage unit 2203.

The link circuit 230 inputs the output of the neuron cell circuit 220 that is an intermediate circuit, to another neuron cell circuit 220. The link circuit 230 may include a switch that is, for example, provided on default wiring indicating the result of machine learning, or provided between the output of the neuron cell circuit 220 as the intermediate circuit and the input of the other neuron cell circuit 220, and the switch can be turned on and off according to an instruction from the outside.

Here, the link circuit 230 may be wired to input the output of one neuron cell circuit 220 that is an intermediate circuit to a plurality of other neuron cell circuit 220.

The link circuit 230 including such a switch can be realized by a well-known crossbar switch. In the well-known crossbar switch, first wiring provided with the outputs of the neuron cell circuits 220 that are intermediate circuits and second wiring connected to the input terminals of the neuron cell circuits 220 on the side that can receive the inputs are crossed, and switches are arranged at the crossed positions. Note that the switches are not depicted in FIG. 2 for the convenience of illustration.

The output-side circuit 240 receives data output by the neuron cell circuit 220 that is an output-end circuit, and outputs the received data to a neuron cell integrated circuit 200 other than the neuron cell integrated circuit 200 including this output-side circuit 240 itself or to the output circuit unit 30.

In one example of the present embodiment, the neuron cell circuits 220 included in one neuron cell integrated circuit 200 may be arranged in a matrix with n rows and m columns as illustrated in FIG. 2, and each of n neuron cell circuits 220 in a first column may be configured to receive at least one piece of N bits of data from the input-side circuit 210.

In this example, at least one of the neuron cell circuits 220 in a second column receives the output as input data from at least one of the neuron cell circuits 220 in the first column through the link circuit 230.

Thereafter, at least one of the neuron cell circuits 220 (corresponding to an i-th neuron cell circuit group) in an i-th column (where i+1<m, that is, intermediate circuits) outputs the output (of the neuron cell circuit 220 in the i-th column) as input data to at least one of the neuron cell circuits 220 in an (i+1)-th column (corresponding to an i-th neuron cell circuit group) through the link circuit 230. In addition, m-th column neuron cell circuits 220 (corresponding to output-end circuits) output the outputs to the output-side circuit 240. In this case, n pieces of N bits of data are output to the output-side circuit 240.

Then, the output circuit unit 30 outputs the data output by the output-side circuits 240 of one or more (here, n) neuron cell integrated circuits 200 that are output-end circuits, to the outside.

### [Operation During Machine Learning]

In the present embodiment, such a circuit as a crossbar switch that can switch the wiring between the neuron cell circuits 220 is used as the link circuit 230 of the information processing apparatus 1 during machine learning, for example. Alternatively, a central processing unit (CPU), a graphics processing unit (GPU), a field-programmable gate array (FPGA), and the like may be used to provide the information processing apparatus 1 as a programmable software-based simulator, and the following process of machine learning may be executed on the simulator.

The information processing apparatus 1 of this example receives, as training data, a plurality of sets of input data and data to be output in response to the input data. Then, for each set, the information processing apparatus 1 sequentially inputs the input data included in the set to the input circuit unit 10 and obtains, through the output circuit unit 30, data to be output by the machine learning processing circuit 20 on the basis of the input data that is input. The information processing apparatus 1 compares the obtained data and the output data corresponding to the input data that is input.

The information processing apparatus 1 controls the switch of the link circuit 230 in each neuron cell integrated circuit 200 included in the machine learning processing circuit 20, on the basis of the result of comparison, and sets the switch such that the output of the machine learning processing circuit 20 when the input data is input becomes close to the output data corresponding to the input data. The operation can be performed by a widely known method of reinforcement learning, such as A. Gaier, D. Ha, “Weight Agnostic Neural Networks,” arXiv: 1906.04358v2.

The information processing apparatus 1 repeats the process for each set included in the training data, to execute machine learning.

### [Operation During Inference]

Once the settings of the switch of the link circuit 230 in each neuron cell integrated circuit 200 included in the machine learning processing circuit 20 is optimized in the machine learning process, the information processing apparatus 1 may fix the wiring to reproduce the settings of the switch. In this case, it is sufficient if the wiring is fixed in the following manner, for example. That is, a layer including first wiring and a layer including second wiring are three-dimensionally crossed. The first wiring is provided with the outputs of the neuron cell circuits 220 for which the link circuit 230 receives the output data among the neuron cell circuits 220 that may be linked by the link circuit 230. The second wiring is connected to the input terminals of the neuron cell circuits 220 on the side that may receive the input. Then, vias are arranged at positions where the wires to be linked are crossed, and the corresponding first wiring and second wiring are linked. Note that the three-dimensional crossing can be performed by layering the wiring layers with arranging an insulating layer in between them, and vias are only required to be formed to penetrate the insulating layer.

Note that, as described later, to form a chip of the neuron cell integrated circuit 200 of the present embodiment, the storage unit 2203 (mask ROM) in the neuron cell circuit 220 may be provided by using a via, and the via included in the link circuit 230 and the via of the storage unit 2203 may be created by the same mask. In this way, the mask manufacturing cost can be reduced.

The information processing apparatus 1 that performs the operation of inference sets in this way the switch of the link circuit 230 in each neuron cell integrated circuit 200 included in the machine learning processing circuit 20, as in the settings optimized by the machine learning process. The information processing apparatus 1 uses the machine learning processing circuit 20 in the machine-learned state to execute the following process.

That is, once the information processing apparatus 1 receives the input data, the information processing apparatus 1 inputs the input data to the input circuit unit 10 and obtains, through the output circuit unit 30, the data output by the machine learning processing circuit 20 on the basis of the input data that is input. The data output by the machine learning processing circuit 20 represents the optimized result, and output data inferred on the basis of the input data is obtained.

### [A Plurality of Types of Non-Linear Functions]

As already described, the non-linear functions as sources of the values held in the storage units 2203 by the neuron cell circuits 220 in one neuron cell integrated circuit 200 may be different from each other.

That is, one neuron cell integrated circuit 200 may include the neuron cell circuits 220 holding values of a plurality of types of non-linear functions, such as a first-type neuron cell circuit 220a including the storage unit 2203 of a first type that holds output results of a first non-linear function corresponding to input values, a second-type neuron cell circuit 220b including the storage unit 2203 of a second type that holds output results of a second non-linear function different from the first non-linear function and corresponding to input values, . . . .

Further, in the present embodiment, when the neuron cell integrated circuit 200 includes the neuron cell circuits 220 arranged in a matrix with n rows and m columns as illustrated in FIG. 2, a group of the neuron cell circuits 220 included in at least one column may include the first-type neuron cell circuits 220a and the second-type neuron cell circuits 220b. In this example, the non-linear functions used in the process of inference can be switched by the settings of the link circuit 230.

In addition, it is also suitable in this example that the non-linearity of the neuron cell circuits (that is, neuron cell circuits closer to the output side) 220 in a j-th column (j>i) be higher on average than the non-linearity of the neuron cell circuits 220 in an i-th column. As for the non-linearity, the closer the value of a parameter a to 0, the lower the non-linearity in the case of a sigmoid function or a Swish function.

Therefore, for example, the neuron cell integrated circuit 200 includes a plurality of neuron cell circuit 220 arranged in n rows and m columns that store the values based on the sigmoid function (or the Swish function) in the storage units 2203, and the values of the parameter a are different from each other (therefore, the non-linear functions are different from each other). In this case, the sum total of the values of the parameter a of the sigmoid function (or the Swish function) held by the neuron cell circuits 220 in the j-th column where j>i may be smaller than the sum total of the values of the parameter a of the sigmoid function (or Swish function) held by the neuron cell circuits 220 in the i-th column.

### [Example of Negative Logic]

In addition, the circuit can generally be simplified by using negative logic in a logic circuit, and therefore, the negative logic may be used in the neuron cell integrated circuit 200. In this case, the values of the non-linear function held by the storage unit 2203 of each neuron cell circuit 220 included in the neuron cell integrated circuit 200 are negative values.

That is, when the function for calculating the value stored in the storage unit 2203 is a sigmoid function,

$$y = - \frac{1}{1 + {e}^{- ax}} \qquad [ Math . 4 ]$$

is used, and when the function is a Swish function,

$$y = - \frac{bx}{1 + {e}^{- ax}} \qquad [ Math . 5 ]$$

is used . . . . In this way, the function is set by multiplying the corresponding non-linear function by −1.

In addition, the input circuit unit 10 inverts each bit of the data input from the outside and outputs the data to the machine learning processing circuit 20 in this example. Further, the output circuit unit 30 inverts each bit of the data output by the machine learning processing circuit 20 and outputs the data.

### [Restriction on Link Circuit]

Further, when the neuron cell integrated circuit 200 includes the neuron cell circuits 220 arranged in a matrix with n rows and m columns in the present embodiment as illustrated in FIG. 2, the number of switches turned on (wires liked to each other) in a link circuit 230j that connects the outputs of the neuron cell circuits 220 in a j-th column (j>i) to the neuron cell circuits 220 in a (j+1)-th column (that is, a link between neuron cell circuits closer to the output side) may be larger than the number of switches turned on (wires linked to each other) in a link circuit 230i that connects the outputs of the neuron cell circuits 220 in an i-th column to the neuron cell circuits 220 in an (i+1)-th column.

That is, the number of input signals received by the input unit of each neuron cell circuit may be set such that there are i and j such that the value of the number Ni of input signals received by the input unit of the neuron cell circuit included in the neuron cell circuits 220 in the i-th column (corresponding to an i-th neuron cell circuit group) is smaller than the value of the number Nj of input signals received by the input unit of the neuron cell circuit 220 included in the neuron cell circuit 220 (corresponding to a j-th neuron cell circuit group) group in the j-th column (j is a natural number equal to or greater than 1 where j>i).

In other words, the number of switches that can be turned on may be restricted in the link circuit 230 that links the outputs of the intermediate circuits closer to the input side to the inputs in the next column.

For example, in the neuron cell integrated circuit 200 including the neuron cell circuits 220 arranged in a matrix with n rows and 10 columns, the number of switches that connect the outputs of the neuron cell circuits 220 included in the first eight columns to the inputs of the neuron cell circuits 220 in the next stage is limited to 2×n. Further, the number of switches that connect the outputs of the neuron cell circuits 220 in the ninth column to the inputs of the neuron cell circuits 220 in the next stage may not be limited. This configuration simulates the configuration of neurons of animals such as a human in which the neurons in a later stage receive more signals and process high-level features.

### [Example of Two Systems for Input to Storage Unit]

In addition, each neuron cell circuit 220 accumulates the input k pieces of data and outputs the value of the non-linear function stored in the address of the storage unit 2203 corresponding to the accumulated value, in the present embodiment. However, the neuron cell circuit 220 of the present embodiment may also have the following configuration.

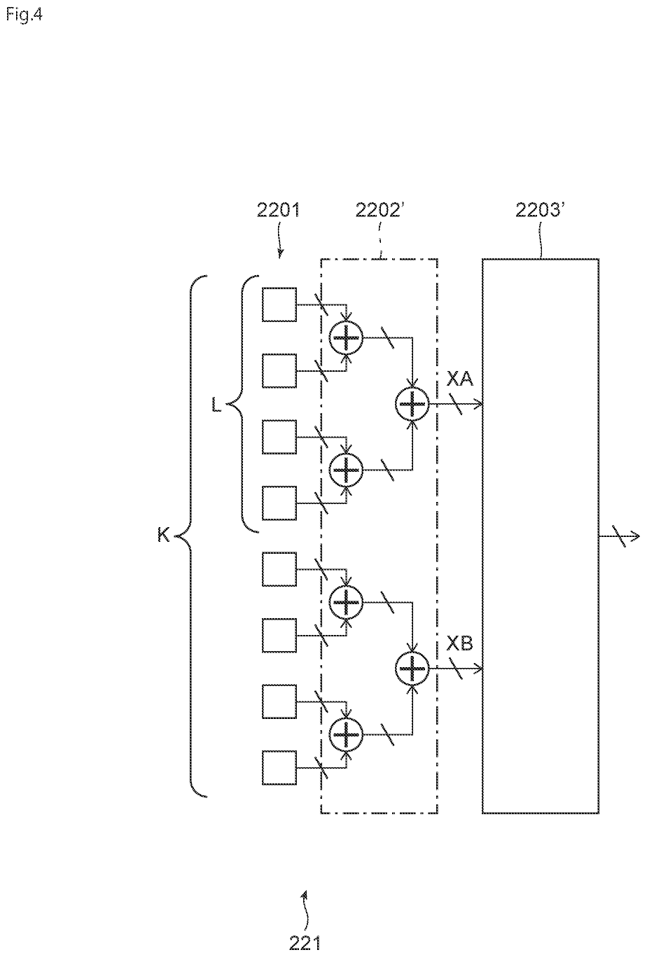

That is, a neuron cell circuit 221 according to one example of the embodiment of the present invention includes the input unit 2201 that receives a plurality of pieces of data, an adder unit 2202′ that accumulates the data received by the input unit 2201, and a storage unit 2203′ as illustrated in FIG. 4. Note that components similar to the components of the neuron cell circuit 220 are provided with the same reference signs, and the description will not be repeated.

The adder unit 2202′ includes a first adder unit 2202a′ that accumulates L pieces (L<K) of input data of the K pieces of input data, and a second adder unit 2202b′ that accumulates the remaining (K−L) pieces of input data.

Further, the adder unit 2202′ outputs an accumulation result XA of the first adder unit 2202a′ and an accumulation result XB of the second adder unit 2202b′.

The storage unit 2203′ holds, in the corresponding address, the value of the non-linear function obtained by multiplying the accumulation result XA and the accumulation result XB by weights different from each other, in order to output the value of the non-linear function. That is, when the Swish function is used as the non-linear function, a value

$$y = \frac{b ( {W}_{p} XA + {W}_{m} XB )}{1 + {e}^{- a ( {W}_{p} XA + {W}_{m} XB )}} \qquad [ Math . 6 ]$$

is written in an address X of the storage unit 2203′ (for example, a value X obtained by providing XA to upper eight bits and XB to lower eight bits when the number of bits of each of XA and XB is eight), where the accumulation result XA is multiplied by a weight Wp and the accumulation result XB is multiplied by a weight Wm. Note that, when the negative logic is used in this example, the value of the function obtained by multiplying the function by −1 is only required to be stored. In addition, Wp=1 and Wm=−1 may be set here.
[Conversion from General Deep Learning Network]

In addition, when positive and negative weights such as Wp and Wm can be applied in this way, the settings (initial settings) of the switch of the link circuit 230 of the neuron cell integrated circuit 200 of the present embodiment may be determined from a deep learning neural network (DNN) already in a machine-learned state.

That is, it is assumed that the weights of the neurons in a layer of the DNN in the machine-learned state are W1=0.08, W2=−0.24, W3=−0.18, W4=0.14, and W5=0.001 for input data X1, X2, X3, X4, and X5, respectively, and the non-linear function is

$$y = \frac{1}{1 + {e}^{- x}} \qquad [ Math . 7 ]$$

(Swish function where a=1 and b=1) used for the multiply and accumulation W1·X1+W2·X2+W3·X3+W4·X4+W5·X5. In this case, the data input from the circuit in the former stage (input-side circuit 210 or another neuron cell circuit 220) is input to the input terminal of the neuron cell circuit 220 that stores, in the storage unit 2203, the value based on the Swish function.

Particularly, the connection is made such that X1 and X3 (multiplied by positive weights) of the data input from the circuit in the former stage are input to an input terminal (InA) in which the weight Wp can be applied, and X2 and X4 (multiplied by negative weights) are input to an input terminal (InB) in which the weight Wm can be applied. That is, the switch settings of the link circuit 230 are set in this way when, for example, the former stage is another neuron cell circuit 220.

Note that the weight coefficient may be “0” for X5 in which the coefficient of the weight is smaller than a predetermined threshold (here, 0.01) in the DNN, and the output X5 in the former stage may not be connected to anywhere. In the case of the connection to the neuron cell circuit 220 just after the input-side circuit 210, the neuron cell integrated circuit 200 does not receive the input of the data X5 from the outside (wiring of the data X5 is not connected to the neuron cell integrated circuit 200).

In addition, Wp and Wm may also be determined as follows in this example. That is, positive values W1 and W4 excluding W5 smaller than the threshold may be used to set the weight Wp to Wp=(W1+W4)/2 on the basis of the statistics (for example, arithmetic mean or the like) of W1 and W4. Similarly, negative values W2 and W3 may be used to set the negative weight Wn to Wn=(W2+W3)/2 on the basis of similar statistics (here, arithmetic mean is used as an example).

For the other neurons of the DNN, the non-linear function used by the neuron is used to select the neuron cell circuit 220, and which input terminal of the selected neuron cell circuit 220 receives (or does not receive) the input from the former stage is set on the basis of the weights that are results of machine learning. In addition, the positive and negative weights are set on the basis of the statistics of the weights that are results of machine learning of the DNN.

In this way, the initial link relation between the neuron cell circuits 220 of the information processing apparatus 1 of the present embodiment is set on the basis of the existing DNN in the machine-learned state. Thereafter, the information processing apparatus 1 executes the already described process of machine learning to optimize the link relation. In addition, the information processing apparatus 1 in this case may also similarly optimize the values Wp and Wn of the weights.

In this example, the initial values are determined on the basis of the DNN already in the machine-learned state, and the machine learning process can thus be more efficient.

### [Other Examples of Two Systems for Input to Storage Unit]

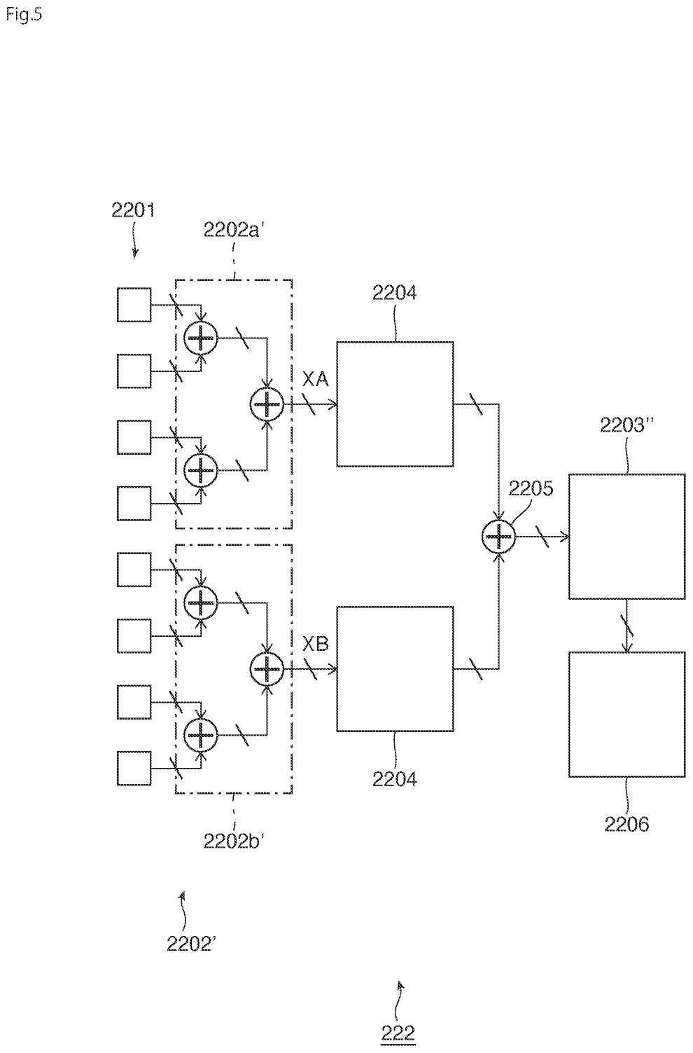

In addition, a neuron cell circuit 222 according to another example of the embodiment of the present invention includes the input unit 2201 that receives a plurality of pieces of data, the adder unit 2202′ that accumulates the data received by the input unit 2201, calculation units 2204, an addition unit 2205, a storage unit 2203″, and an output unit 2206 as illustrated in FIG. 5. Note that the same reference signs are provided to components similar to the components of the neuron cell circuits 220 and 221, and the description will not be repeated.

In this example, the adder unit 2202′ is also configured to output the accumulation result XA of the first adder unit 2202a′ and the accumulation result XB of the second adder unit 2202b′. However, it is assumed here that the accumulation result XA and the accumulation result XB include signed binary numbers with the same number of bits (z bits each).

Two calculation units 2204 corresponding to the accumulation result XA and the accumulation result XB are provided, and each of the calculation units 2204 may be a storage unit (memory such as ROM) that stores, in a corresponding memory address, a value obtained as a result of applying a predetermined non-linear function to an address value corresponding to, for example, z bits of address value XA or XB. Here, the value of the result of the non-linear function is z bits of value corresponding to the bit width of the output data.

That is, the calculation units 2204 in this example output the values of the non-linear function stored in the memory addresses corresponding to the input accumulation results XA and XB. Here, the calculation units 2204 may be realized by shift operators instead of the memories. In this case, the calculation units 2204 corresponding to the accumulation result XA and the accumulation result XB may apply arithmetic shift operations in directions different from each other to the corresponding accumulation results XA and XB and output the results. For example, the calculation unit 2204 that has received the input of the accumulation result XA shifts the accumulation result XA to the right by n bits (for example, may be n=1) and outputs the result. In addition, the calculation unit 2204 that has received the input of the accumulation result XB shifts the accumulation result XB to the left by n bits (for example, may be n=1) and outputs the result. In this example, the bit width of the result of the arithmetic shift operation is also z bits of value corresponding to the bit width of the output data, and the bits overflown in the arithmetic shift operation are discarded.

The addition unit 2205 adds the data output by the calculation unit 2204 corresponding to the accumulation result XA and the accumulation result XB, to obtain z bits of addition result X.

The storage unit 2203″ is configured to store, for each z bits of memory address corresponding to the z bits of addition result X, the value of the result obtained by applying a predetermined non-linear function to an address value indicated in the memory address. Here, the value of the result of the non-linear function is z bits of value corresponding to the bit width of the output data. The storage unit 2203″ outputs the value of the non-linear function stored in the memory address corresponding to the input addition result X.

The output unit 2206 outputs the value output by the storage unit 2203″ to the outside. Note that the output unit 2206 may perform a calculation to obtain a result of further applying a correction function for taking into account the non-linearity to the output of the storage unit 2203″ and output the value after the application of the correction function.

The neuron cell circuit of this example is preferable when a non-linear function h (x) with low non-linearity is used, that is, when approximation of h (x1+x2)=h (x1)+h (x2) holds in a range that the input value x1+x2 is close to 0.

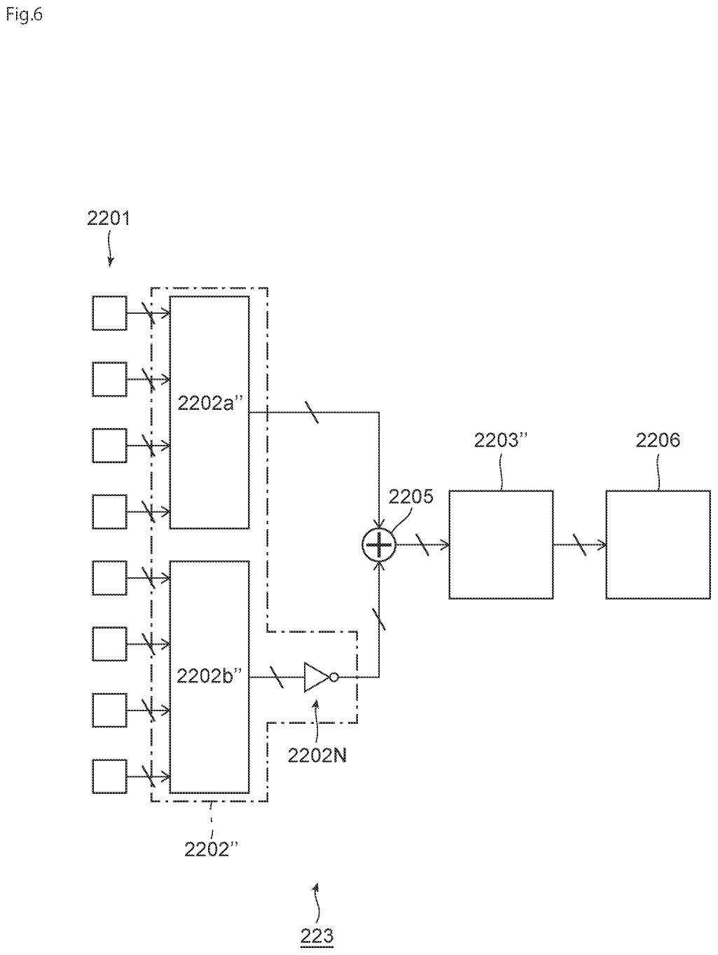

A neuron cell circuit 223 according to still another example includes the input unit 2201 that receives a plurality of pieces of data, an adder unit 2202″, the storage unit 2203″, and the output unit 2206 as illustrated in FIG. 6. Note that the same reference signs are provided to components similar to the components of the neuron cell circuits 220 and 221, and the description will not be repeated.

In this example, the adder unit 2202″ includes a first adder unit 2202a″, a second adder unit 2202b″, an inversion unit 2202N, and the addition unit 2205. The adder unit 2202a″ accumulates L pieces (L<K) of input data of K pieces of input data. In addition, the adder unit 2202b″ accumulates the remaining (K−L) pieces of input data. The inversion unit 2202N inverts the positive and negative of the value output by the adder unit 2202b″.

Further, the addition unit 2205 of the adder unit 2202″ outputs an addition result X (X=XA−XB) obtained by adding an accumulation result XA output by the first adder unit 2202a″ and a result −XB output by the second adder unit 2202b″ in which the positive and negative is inverted. That is, the example of the present embodiment using the adder unit 2202″ corresponds to a case in which the weight Wp applied to the accumulation result XA is “1” and the weight Wm applied to the accumulation result XB is “−1.” In addition, it is assumed here that the accumulation results XA and XB and the addition result X include signed binary numbers with the same number of bits (z bits each).

As already described, the storage unit 2203″ stores, for each z bits of memory address corresponding to z bits of addition result X, the value obtained as a result of applying the predetermined non-linear function to the address value indicated in the memory address. Here, the z bits of addition result X is expressed by a signed binary number. Therefore, the most significant bit is a sign bit, and the remaining z−1 bits indicate the value. In the case of the memory address, the addition result X is handled as z bits of value. That is, in the case of z=four bits, for example, the memory address corresponding to the addition result X of “−1” (expression of two's complement is adopted) is a binary number “1111.”

In addition, the value of the result of the non-linear function here is z bits of value corresponding to the bit width of the output data. The storage unit 2203″ outputs the value of the non-linear function stored in the memory address corresponding to the input addition result X.

The output unit 2206 outputs the value output by the storage unit 2203″ to the outside. Note that the output unit 2206 may perform a calculation to obtain a result of further applying a correction function for taking into account the non-linearity to the output of the storage unit 2203″ and output the value after the application of the correction function.

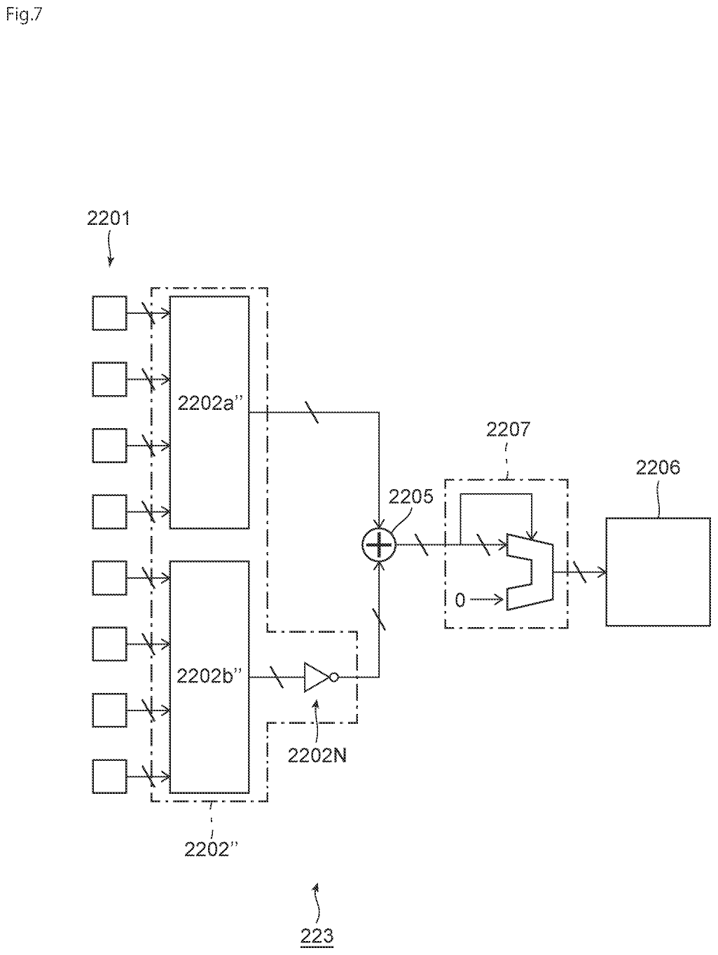

Further, the storage unit 2203″ may be replaced with a predetermined calculation circuit in this example. FIG. 7 illustrates an example of arranging a Relu calculation circuit unit 2207 in place of the storage unit 2203″ in the neuron cell circuit 223 illustrated in FIG. 6.

The Relu calculation circuit unit 2207 refers to the sign bit of the input value X (addition result X output by the adder unit 2202″). The Relu calculation circuit unit 2207 outputs a value of z bit length indicating “0” regardless of the input value when the sign bit is “1” (negative), and outputs the input value X as is when the sign bit is “0” (positive).

According to this example, the storage unit 2203″ does not have to be implemented, and the configuration of the hardware can be simple. Note that, although the Relu calculation circuit is described as an example of the calculation circuit here, the present embodiment is not limited to this, and any circuit can be used as long as the circuit indicates a function (particularly, a non-linear function) that can be realized by simple hardware, such as a circuit that outputs an calculation result of a HardSwish function.

### [Overflow Prevention]

In addition, the calculation result of the adder unit 2202 (so to speak, because the weight is “1,” and the data is accumulated) tends to overflow (exceeds the maximum value) in each neuron cell circuit 220 in the present embodiment.

Therefore, with respect to a bit number N of the data, the bit number of a variable used in the addition calculation in the adder unit 2202 may be M (M is an integer where M>N), and the adder unit 2202 may output M bits of accumulation result.

In this case, the storage unit 2203 may store, in M bits of address space, the value (the value includes N bits) of the non-linear function corresponding to the address value.

Similarly, with respect to the number of bits N of the data, the number of bits of the variable used in the addition calculation in the adder unit 2202 may be M (M is an integer where M>N). When the adder unit 2202 outputs M bits of accumulation result, whether or not each bit from an (N+1)-th bit to an M-th bit in the accumulation result includes “1” (whether or not the accumulation of N bits is overflown) may be checked. The maximum value of the N bits may be output to the storage unit 2203 if there is “1” (overflown), and the accumulation result may be output if there is no “1” (not overflown).

In this case, the storage unit 2203 stores, in N bits of address space, the value (N bits) of the non-linear function corresponding to the address value as already described above. According to these methods, the overflow can be handled.

### [Neuron Cell Circuit for Pooling Layer]

Note that, in a convolutional network (convolutional neural network (CNN)) recognized as effective in image processing and the like, a process called a pooling process is widely used. To execute the pooling process in the present embodiment, the value stored in the storage unit 2203 can be, for example, a value α/k obtained by dividing a constant α by the number k of pieces of input data, regardless of each corresponding address value x.

The output of the neuron cell circuit 220 in this case is the same as the output after the execution of average pooling.

### [Programmable ROM]

Note that, as already described, from among the neuron cell circuits 220 included in the neuron cell integrated circuit 200, some neuron cell circuits 220 has the storage unit 2203 which may include a writable storage element to allow rewriting of the value stored in the storage unit 2203, and writing of a value from the outside may be accepted.

In this case, the non-linear function used by the neuron cell circuit 220 including rewritable memory can also be the target of machine learning in the course of machine learning. Note that such neuron cell circuits 220 (referred to as rewritable neuron cell circuits) may be arranged only in an m-th column close to the output side or only from the m-th column to an (m−q)-th column (q<m) among the neuron cell circuits 220 arranged in n rows and m columns. Alternatively, the rewritable neuron cell circuits may be arranged only in a first column close to the input side or only from the first column to a q-th column (q<m) among the neuron cell circuits 220 arranged in n rows and m columns.

Note that, when one neuron cell integrated circuit 200 is provided with both the non-rewritable neuron cell circuits 220 and the rewritable neuron cell circuits 220, it may be preferable to arrange more rewritable neuron cell circuits 220 in later stages close to the output.

### [Retention of Information by Shift Register]

In addition, each neuron cell circuit 220 may receive the input of data through a shift register circuit in an example of the present embodiment.

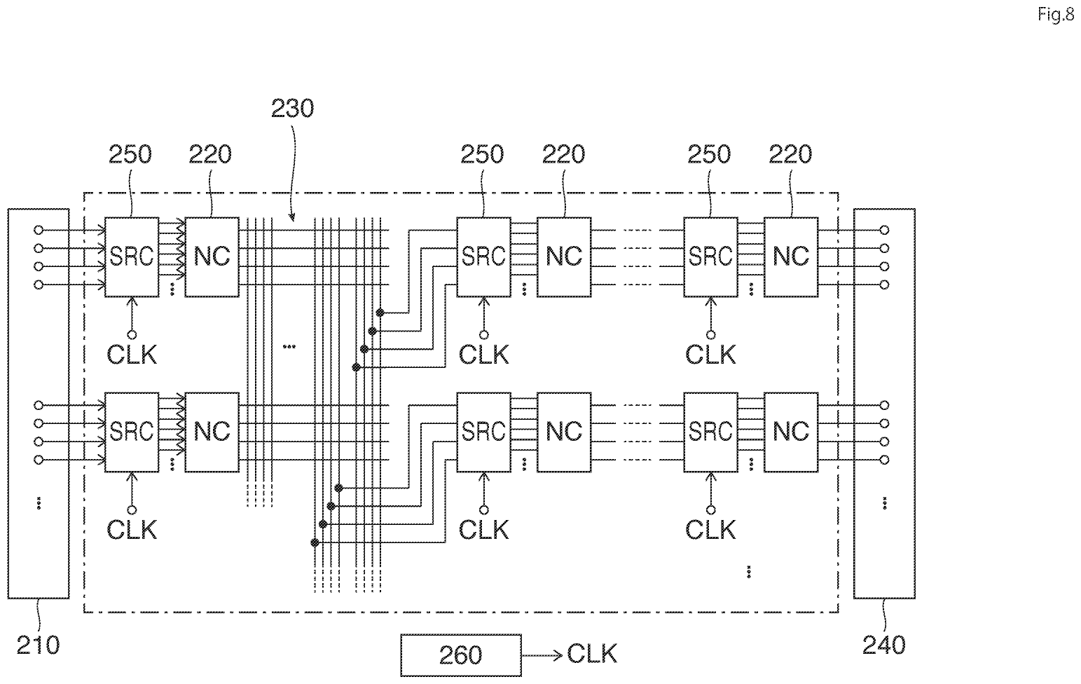

The machine learning processing circuit 20 according to this example includes at least one neuron cell integrated circuit 200 as illustrated in FIG. 8. The neuron cell integrated circuit 200 in this example includes the input-side circuit 210, a plurality of neuron cell circuit 220 (abbreviated as NC in the drawings), shift register circuit units 250 corresponding to the respective neuron cell circuits 220, a clock circuit 260, the link circuit 230, and the output-side circuit 240.

In addition, the shift register circuit unit 250 here is configured to receive the input of data at every predetermined timing and hold the data input in a predetermined number of times (for example, q times) in the past. In addition, the shift register circuit unit 250 outputs at least some pieces of the held data of q times to the neuron cell circuit 220 and the like connected in the later stage at the predetermined timing.

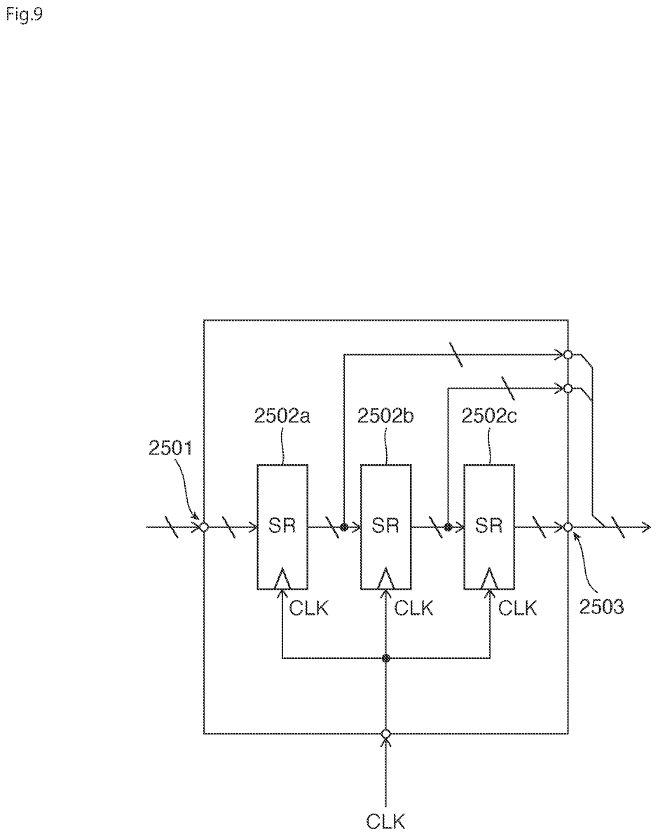

Specifically, the shift register circuit unit 250 includes an input terminal 2501, q (q is a natural number equal to or greater than 1) shift registers (abbreviated as SR in the drawings) 2502, and an output terminal 2503 as illustrated in FIG. 9.

Further, the shift register 2502 includes an input terminal IN that receives an input of P bits of data (P is a natural number equal to or greater than 1) from the input-side circuit 210 or the link circuit 230, an output terminal OUT that outputs the P bits of data, and an input terminal CLK of a clock signal. Note that, when q>1, the plurality of shift registers 2502a, 2052b, . . . are connected to one another in series in multiple stages. In addition, the plurality of shift registers 2502a, 2502b, . . . will simply be referred to as shift registers 2502 when they are not distinguished.

The input terminal 2501 of the shift register circuit unit 250 receives the input of P bits of data from the input-side circuit 210 or the link circuit 230 and outputs the data to the input terminal IN of the shift register 2502 (the shift register 2502a in a first stage when there are a plurality of shift registers 2502).

The shift register 2502 temporarily holds the P bits of data input to the input terminal IN, when the shift register 2502 receives the input of a clock signal. In addition, the shift register 2502 outputs the data held last time from the output terminal OUT once the shift register 2502 receives the input of the clock signal. Note that there is no data to be held just after the power input, and therefore, the shift register 2502 initializes each bit of the held data to a predetermined value such as “0.”

In addition, the output terminal OUT of the shift register 2502 is connected to the input terminal IN of the shift register 2502 of a later stage when there is a shift register 2502 in the later stage, and the output terminal OUT is connected to the output terminal 2503 of the shift register circuit unit 250 when there is no shift register 2502 in the later stage (in the case of a shift register in the last stage).

The shift register circuit unit 250 configured in this way temporarily holds the P bits of data input in q times in the past and outputs the data held q times before.

Note that the output terminals OUT of at least some of the shift registers 2502 not in the last stage (that is, in the first stage and intermediate stages) among the shift registers 2502 connected in multiple stages may be connected not only to the input terminals IN of the shift registers 2502 in later stages, but also to the output terminal 2503 of the shift register circuit unit 250. In this example, the data held q times before, the data held q−1 times before, . . . and the data held last time are output.

In addition, in one example of the present embodiment, the input terminal 2501 of the shift register circuit unit 250 is connected to the input terminal IN of the shift register 2502a in the first stage and may also be connected to the output terminal 2503 of the shift register circuit unit 250. Hereinafter, it is assumed that, as illustrated in FIG. 9, the input terminal 2501 of the shift register circuit unit 250 is connected only to the input terminal IN of the shift register 2502a in the first stage, and the output terminals OUT of the shift registers 2502a and 2502b in the first stage and the intermediate stage are connected to the input terminals of the shift registers 2502b and 2502c in the later stages and also to the output terminal 2503 of the shift register circuit unit 250.

Further, as already described, the output terminal OUT of the shift register 2502c in the last stage is connected to the output terminal 2503 of the shift register circuit unit 250. That is, the output terminal 2503 of the shift register circuit unit 250 outputs (P×3) bits of data in this example.

The data output by the output terminal 2503 is output to the neuron cell circuit 220 corresponding to the shift register circuit unit 250. Note that it is assumed that the bit width of the data that can be input to the input ports of the corresponding neuron cell circuit 220 is equal to or greater than the bit width output by the corresponding shift register circuit unit 250. Specifically, when each neuron cell circuit 220 includes K pieces of N bit input ports (K×N bits of input ports in total), it is sufficient in the above example if K×N≥P×3 holds.

The clock circuit 260 outputs a clock signal (pulse signal) that alternately repeats a state of “H” and a state of “L” at every predetermined clock timing, to the input terminal CLK of the clock signal of each shift register 2502.

When the information processing apparatus 1 according to this example of the present embodiment is used, a crossbar switch or the like that can switch the wiring is used as the link circuit 230 during the machine learning, for example. Further, the information processing apparatus 1 receives, as training data, a plurality of sets of input data and data to be output in response to the input data. The information processing apparatus 1 then sequentially applies the following process of machine learning to each set.

That is, the information processing apparatus 1 divides input data D included in the set as the target of machine learning, into predetermined units, to obtain divided input data di (i=1, 2, . . . ). The information processing apparatus 1 sequentially inputs the divided input data di to the input circuit unit 10 at every predetermined clock timing.

Every time the divided input data di is input, the input circuit unit 10 outputs the divided input data di to the neuron cell integrated circuit 200. The input-side circuit 210 of the neuron cell integrated circuit 200 further divides the divided input data di, which has been input thereto, into pieces of P bits of data and outputs each piece of the P bits of data to the corresponding shift register circuit units 250.

It is assumed in the following description that the neuron cell integrated circuit 200 includes 3 sets×2 stages of the shift register circuit units 250 and the corresponding neuron cell circuits 220, and the link circuits 230 are arranged between the stages. Needless to say, this is an example, and a larger number of sets of shift register circuit units 250 and corresponding neuron cell circuits 220 and a larger number of link circuits 230 may be included. In addition, it is assumed in the following example that the shift register circuit unit 250 includes q (q is a natural number equal to or greater than 1) shift registers 2502.

In this example, each of the three shift register circuit units 250a in the first stage receives the input of P bits of data from the input circuit unit 10. Further, each shift register circuit unit 250a holds P bits of data input in q times in the past and outputs q−1 pieces of P bits of data ((q−1)×P bits of data) input from q times before to the last time to the neuron cell circuit 220a corresponding to the shift register circuit unit 250a at every clock timing.

Here, when the neuron cell circuit 220 is the circuit illustrated in FIG. 3, for example, the neuron cell circuit 220a accumulates the input (q−1)×P bits of data and outputs the data that is stored in the storage element 2203 and that indicates the value of the function corresponding to the accumulation result.

The output data is output to the shift register circuit unit 250b in the later stage via the link circuit 230. Further, the shift register circuit unit 250b in the later stage also holds P bits of data input in q times in the past and outputs q−1 pieces of P bits of data ((q−1)×P bits of data) input from q times before to the last time to the neuron cell circuit 220b corresponding to the shift register circuit unit 250b at every clock timing. Further, the neuron cell circuit 220b that has received the input of the data accumulates the input (q−1)×P bits of data and outputs the data that is stored in the storage element 2203 and that indicates the value of the function corresponding to the accumulation result.

The information processing apparatus 1 obtains the data output by the neuron cell circuit 220b in the last stage through the output circuit unit 30 and compares the obtained data and the output data corresponding to the input data that is input.

The information processing apparatus 1 can control the switch of the link circuit 230 in the neuron cell integrated circuit 200 on the basis of the result of comparison and use the already-described widely-known method of reinforcement learning, such as A. Gaier, D. Ha, “Weight Agnostic Neural Networks,” arXiv: 1906.04358v2, to set the output of the machine learning processing circuit 20 when the input data is input, such that the output becomes close to the output data corresponding to the input data.

The information processing apparatus 1 repeats the process for each set included in the training data, to execute the machine learning.

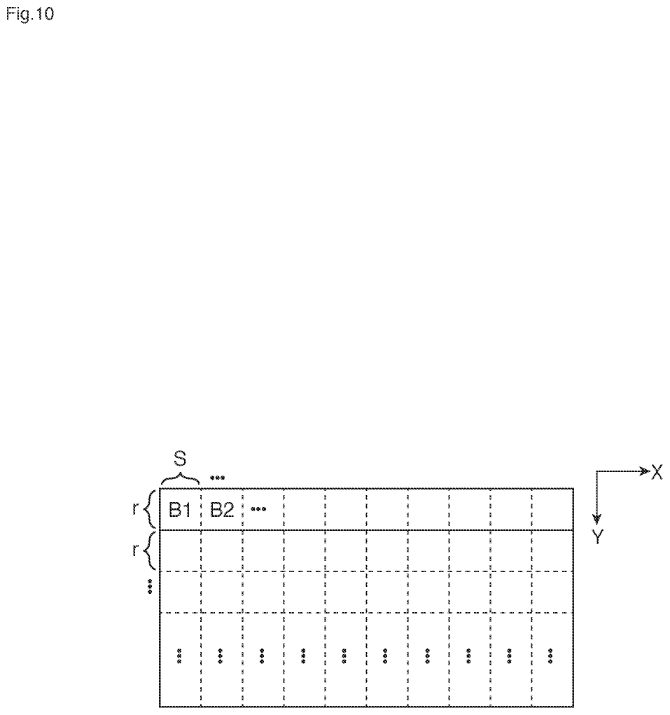

The information processing apparatus 1 can preferably be used to execute machine learning related to, for example, image data. That is, to execute the machine learning related to image data, the information processing apparatus 1 uses the image data as input data as illustrated in FIG. 10, divides the input data into line blocks including r rows (r is a natural number equal to or greater than 1) to obtain divided input data, and sequentially inputs the line blocks of every r row to the input circuit unit 10 at every predetermined clock timing.

In this example, the input circuit unit 10 receives, as the divided input data, the input of the line blocks from a first row to an r-th row at a first clock timing, the input of the line blocks from an (r+1)-th row to a 2r-th row at the next clock timing, and so forth. The input circuit unit 10 outputs the received data of line blocks to the neuron cell integrated circuit 200. Consequently, the input-side circuit 210 of the neuron cell integrated circuit 200 further divides the input line blocks into blocks B1, B2 . . . of r×s pixels (the P bits) including pixel sequences of s columns (s is a natural number equal to or greater than 1) or more, and outputs each block to the neuron cell circuit 220 via the corresponding shift register circuit unit 250.

According to the example, the machine learning related to image data is performed for every q (the number of stages of the shift registers 2502) line blocks adjacent to each other in the vertical direction of the image. In addition, the neuron cell circuit 220 may be provided for each channel (for example, data of color component such as red (R), green (G), blue (B), and alpha channel (e.g., transparency)), and the neuron cell circuits 220 may execute the process in parallel.

Next, an operation example during the inference of the information processing apparatus 1 including the machine learning processing circuit 20 with the shift registers will be described.

The information processing apparatus 1 executes the machine learning process to fix, in the optimized (machine-learned) state, the settings of the switches of the link circuits 230 in each neuron cell integrated circuit 200 included in the machine learning processing circuit 20, and then executes the process of inference. The method already described can be adopted for the method of fixing the switches here, and the description will not be repeated.

The information processing apparatus 1 that performs the operation of inference executes the process of inference as follows in the state in which the switches of the link circuits 230 in each neuron cell integrated circuit 200 included in the machine learning processing circuit 20 are set as in the settings optimized by the machine learning process. Hereinafter, in this example, it is assumed that the configuration is similar to the configuration of the machine learning processing circuit 20 used in the process of machine learning.

Once the information processing apparatus 1 receives the input data as the target of the process of inference, the information processing apparatus 1 divides the input data into predetermined units to obtain divided input data di (i=1, 2, . . . ). Further, the information processing apparatus 1 sequentially inputs the divided input data di to the input circuit unit 10 at every predetermined clock timing.

The input circuit unit 10 outputs the divided input data di to the neuron cell integrated circuit 200 every time the divided input data di is input. The input-side circuit 210 of the neuron cell integrated circuit 200 further divides the divided input data di, which has been input thereto, into pieces of P bits of data and outputs each piece of the P bits of data to the corresponding shift register circuit unit 250.

Consequently, each of the three shift register circuit units 250a in the first stage receives the input of P bits of data from the input circuit unit 10. Further, each shift register circuit unit 250a holds P bits of data input in q times in the past and outputs q−1 pieces of P bits of data ((q−1)×P bits of data) input from q times before to the last time to the neuron cell circuit 220a corresponding to the shift register circuit unit 250a at every clock timing.

Here, in this example, the neuron cell circuit 220 is a circuit illustrated in FIG. 3. Therefore, the neuron cell circuit 220a accumulates the input (q−1)×P bits of data and outputs the data that is stored in the storage element 2203 and that indicates the value of the function corresponding to the accumulation result.

The output data is output to the shift register circuit unit 250b in the later stage via the link circuit 230. Further, the shift register circuit unit 250b in the later stage also holds P bits of data input in q times in the past and outputs q−1 pieces of P bits of data ((q−1)×P bits of data) input from q times before to the last time to the neuron cell circuit 220b corresponding to the shift register circuit unit 250b at every clock timing. Further, the neuron cell circuit 220b that has received the input of the data accumulates the input (q−1)×P bits of data and outputs the data that is stored in the storage element 2203 and that indicates the value of the function corresponding to the accumulation result.

The information processing apparatus 1 obtains the data output by the neuron cell circuit 220b in the last stage through the output circuit unit 30. The data represents the optimized result, and the data is output data inferred on the basis of the input data.

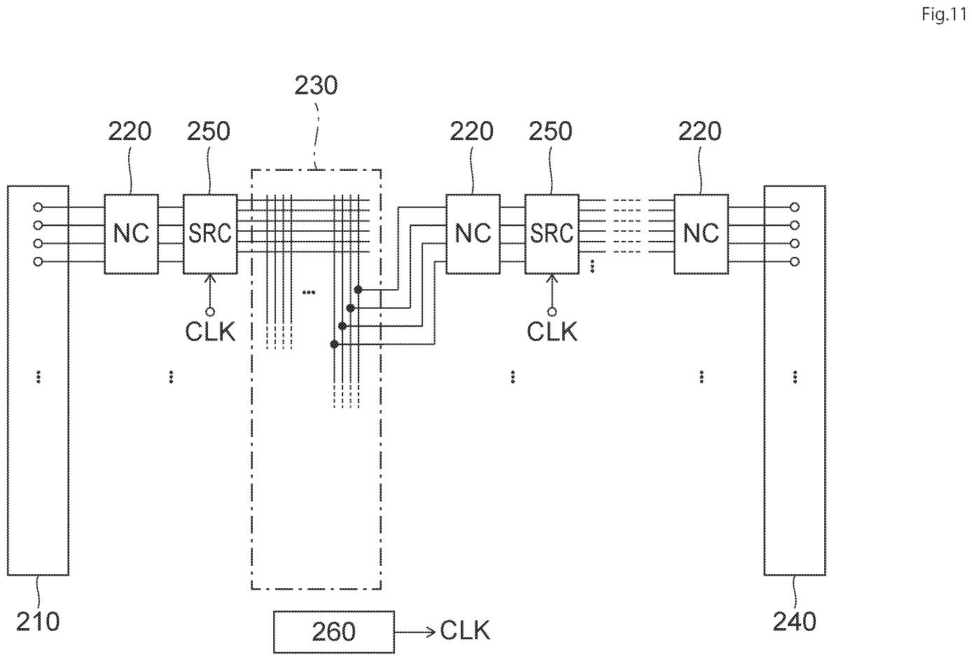

Note that, although the shift register circuit unit 250 is arranged in the former stage of the corresponding neuron cell circuit 220 in the description so far, the shift register circuit unit 250 may be arranged in the later stage of the corresponding neuron cell circuit 220 as illustrated in FIG. 11 corresponding to FIG. 8. Note that, when the shift register circuit unit 250 is arranged in the later stage of the neuron cell circuit 220 in this way, the link circuit 230 mutually links k×P bits of data (here, k is an integer equal to or greater than 1 and equal to or smaller than q, such as k=q−1) output by the shift register circuit unit 250 and wiring corresponding to the number of bits input to the shift register circuit unit 250 of the next stage.

According to the examples of the present embodiment, data related to a plurality of points which are temporally or spatially adjacent or close to each other can be used to apply the process of machine learning or inference to time-series data such as a sound and a vibration and to data expressing information with spatial breadth, such as an image. In addition, the neuron cell circuits 220 corresponding to the plurality of points which are temporally or spatially adjacent or close to each other do not have to be provided, and this can suppress the increase in the circuit scale.

In addition, the neuron cell circuits 220 are used in the description so far. Instead of this, the neuron cell circuits 221 as well as the neuron cell circuits 222 and 223 illustrated in FIGS. 4 and 5 may be used as two systems for input to the storage unit.

[Link Circuit with Storage Elements]

In addition, although the link circuit 230 uses the crossbar switch or the like during the machine learning and uses the vias or the like to link the corresponding wires after the completion of the machine learning in the examples described above, the present embodiment is not limited to these examples.

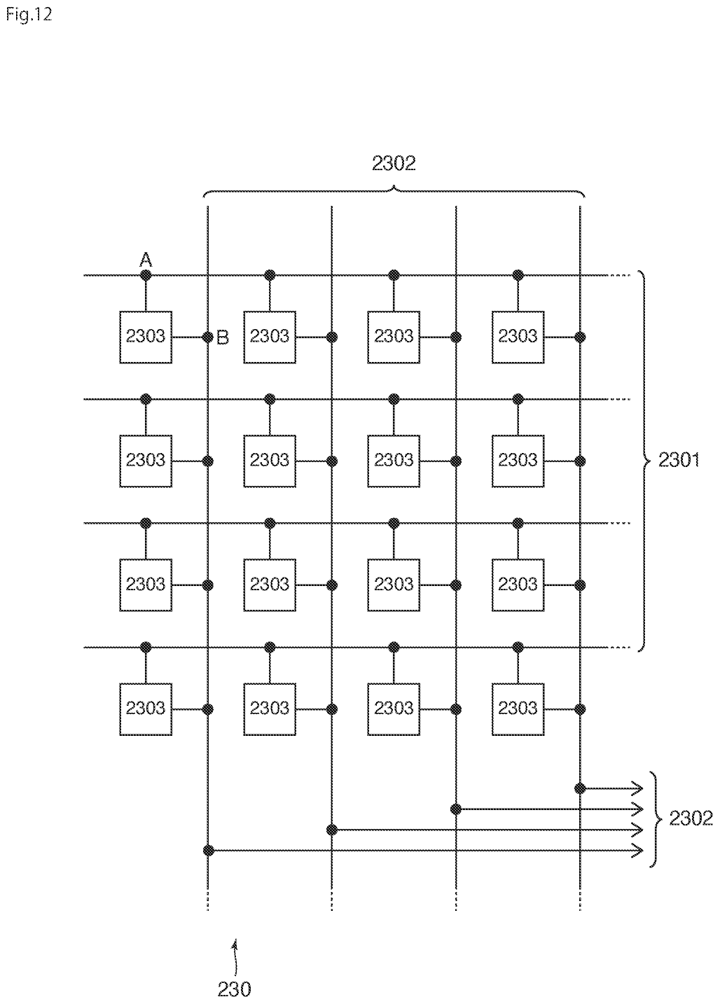

As illustrated in FIG. 12, in the link circuit 230 of an example of the present embodiment, first wiring 2301 provided with the outputs (wiring column corresponding to each bit) of the neuron cell circuits 220 in the former stages and second wiring 2302 (wiring column corresponding to each bit of input data) connected to the input terminals of the neuron cell circuits 220 in the later stages on the side that can receive the input of the data output by the neuron cell circuits 220 in the former stages may be crossed, and switch circuits 2303 with storage elements may be arranged at all crossed positions of the wiring of the first wiring 2301 corresponding to each bit and the wiring of the second wiring 2302 corresponding to each bit.

The switch circuit 2303 is in either a state in which wiring A corresponding to a bit of the corresponding first wiring 2301 and wiring B corresponding to a bit of the second wiring 2302 are electrically connected to each other, or a state in which the wiring A and the wiring B are not electrically connected to each other. These states can be switched according to an instruction from the outside.

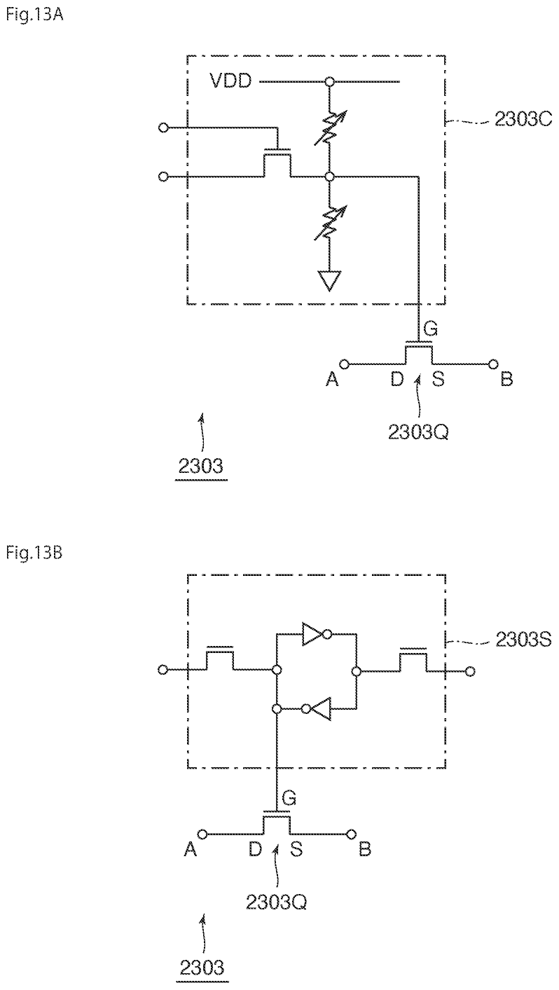

Specifically, the switch circuit 2303 may include a non-volatile memory (NVM) cell 2303C such as a ReRAM, and a field-effect transistor (FET) 2303Q that is a switch, as illustrated in FIG. 13A. In this example, the wiring A and the wiring B are connected to a drain terminal (D) and a source terminal (S) of the FET 2303Q, respectively, and a bit line of the non-volatile memory cell (2303C) is connected to a gate terminal (G) of the FET 2303Q.

The non-volatile memory cell 2303C is switched by a signal input from the outside, to perform a set operation or a reset operation, and the non-volatile memory cell 2303C changes the state of H and L of the signal to be output through the bit line. Note that the operation of the non-volatile memory cell 2303C and the method of switching the non-volatile memory cell 2303C is widely known, and the method will not be described here.

The FET 2303Q electrically connects the source terminal and the gate terminal to each other to electrically link the wiring A and the wiring B when the signal output through the bit line of the non-volatile memory cell 2303C is, for example, H. In addition, the FET 23030 cuts off the electrical connection between the source terminal and the gate terminal to electrically separate the wiring A and the wiring B when the signal output through the bit line of the non-volatile memory cell 2303C is, for example, L.

According to the configuration, the link circuit 230 can use the signal from the outside to change the state of transfer of data between the neuron cell circuits 220. Note that, even when the state of transfer of data is fixed to execute the inference process, the circuit does not have to be changed, and the link circuit 230 including the switch circuits 2303 may be used to execute the process of inference and the like.

Note that the increase in the circuit scale can also be suppressed when the non-volatile memory cell 2302C is a cell with a relatively small circuit scale.

Further, in another example of the present embodiment, the switch circuit 2303 may include a volatile memory cell 2303S such as a SRAM as illustrated in FIG. 13B. The operation of the switch circuit 2303 with the volatile memory cell 2303S is basically similar to the operation illustrated in FIG. 13A, and the difference is that the volatile memory cell 2303S is used as a storage element.

According to this example, the settings of the link circuit 230 can easily dynamically be switched, and the information processing apparatus 1 can be used in a variety of applications.

In addition, as illustrated in FIGS. 13A and 13B and the like, when the link circuit 230 includes a storage element, the storage unit 2203 of the neuron cell circuit 220 may also include the same type of storage element.

In addition, the neuron cell circuits 220 are used in the description so far. Instead of this, the neuron cell circuits 221 as well as the neuron cell circuits 222 and 223 illustrated in FIGS. 4 and 5 may be used as two systems for input to the storage unit.

### [Formation of Chip]

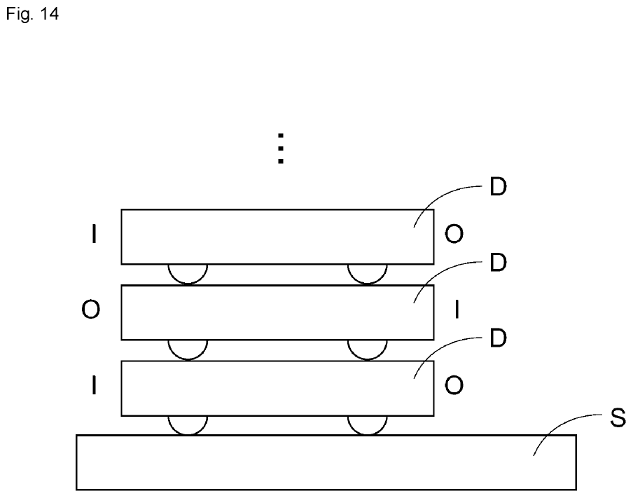

In addition, a chip die D provided with the neuron cell circuits 220 of the present embodiment may be formed to obtain the neuron cell integrated circuit 200 as a chip. Further, input sides I and output sides O of the chip dies D may alternately be layered on a package substrate S to seal a plurality of neuron cell integrated circuit 200 in one package, as illustrated in FIG. 14. Note that the package may further include other chip parts such as a CPU module, a GPU, and a conventional artificial intelligence (AI) (e.g., as deep learning) chip. When a combination of the CPU module and the like is included in this way, the part may include machine learning means for receiving and processing the output of the neuron cell circuits 220 of the present embodiment. In this example, machine learning may further be performed for the machine learning means including the CPU module and the like.

### REFERENCE SIGNS LIST

1: Information processing apparatus
10: Input circuit unit
20: Machine learning processing circuit
30: Output circuit unit
200: Neuron cell integrated circuit
210: Input-side circuit
220, 221, 222, 223: Neuron cell circuit
230: Link circuit
240: Output-side circuit
250: Shift register circuit unit
2201: Input unit
2202, 2202′: Adder unit
2203, 2203′, 2203″: Storage unit
2204: Calculation unit
2205: Addition unit
2206: Output unit

1-11. (canceled)

12. A machine learning processing circuit including a plurality of neuron cell circuit,
each of the plurality of neuron cell circuit comprises:
an input unit that receives a plurality of input signals,
an adder unit that adds the input signals received by the input unit, and
a storage unit that holds output results of a non-linear function corresponding to input values, uses an output signal output by the adder unit, as an input value, and outputs an output result of the non-linear function corresponding to the input value.

13. The machine learning processing circuit according to claim 12, further comprising:
a switch circuit that uses some of the plurality of neuron cell circuit as output-end circuits, uses the plurality of neuron cell circuit other than the output-end circuits as intermediate circuits, and switches whether or not to connect an output signal of each of the neuron cell circuits included in the intermediate circuits to an input unit of a corresponding one of other neuron cell circuits, wherein
the machine learning processing circuit updates a link relation between the neuron cell circuits through the switch circuit during machine learning.

14. The machine learning processing circuit according to claim 12, further comprising:
a link circuit that uses some of the plurality of neuron cell circuit as output-end circuits, uses the plurality of neuron cell circuit other than the output-end circuits as intermediate circuits, and connects an output signal of each of the neuron cell circuits included in the intermediate circuits to input units of at least some of other neuron cell circuits.

15. The machine learning processing circuit according to claim 12, wherein
the plurality of neuron cell circuit are sorted into a plurality of neuron cell circuit groups each including a plurality of neuron cell circuit,
the machine learning processing circuit further includes a switch circuit that switches whether or not to connect an output signal of each of the neuron cell circuits included in an i-th (i is a natural number equal to or greater than 1) neuron cell circuit group to an input unit of a corresponding one of the neuron cell circuits included in an (i+1)-th neuron cell circuit group, and
the machine learning processing circuit updates a link relation between the neuron cell circuits through the switch circuit during machine learning.

16. The machine learning processing circuit according to claim 13, wherein
the plurality of neuron cell circuit are sorted into a plurality of neuron cell circuit groups each including a plurality of neuron cell circuit,
the machine learning processing circuit further includes a switch circuit that switches whether or not to connect an output signal of each of the neuron cell circuits included in an i-th (i is a natural number equal to or greater than 1) neuron cell circuit group to an input unit of a corresponding one of the neuron cell circuits included in an (i+1)-th neuron cell circuit group, and
the machine learning processing circuit updates a link relation between the neuron cell circuits through the switch circuit during machine learning.

17. The machine learning processing circuit according to claim 12 wherein
the plurality of neuron cell circuit are sorted into a plurality of neuron cell circuit groups each including a plurality of neuron cell circuit, and
the machine learning processing circuit further includes a link circuit that connects an output signal of each of the neuron cell circuits included in an i-th (i is a natural number equal to or greater than 1) neuron cell circuit group to input units of at least some of the neuron cell circuits included in an (i+1)-th neuron cell circuit group.

18. The machine learning processing circuit according to claim 14 wherein
the plurality of neuron cell circuit are sorted into a plurality of neuron cell circuit groups each including a plurality of neuron cell circuit, and
the machine learning processing circuit further includes a link circuit that connects an output signal of each of the neuron cell circuits included in an i-th (i is a natural number equal to or greater than 1) neuron cell circuit group to input units of at least some of the neuron cell circuits included in an (i+1)-th neuron cell circuit group.

19. The machine learning processing circuit according to claim 15, wherein
the number of input signals received by the input unit of each of the neuron cell circuits is set such that there are i and j where a value of the number Ni of input signals received by the input units of the neuron cell circuits included in the i-th (i is a natural number equal to or greater than 1) neuron cell circuit group is smaller than a value of the number Nj of input signals received by the input units of the neuron cell circuits included in a j-th (j is a natural number equal to or greater than 1 where j>i) neuron cell circuit group.

20. The machine learning processing circuit according to claim 16, wherein
the number of input signals received by the input unit of each of the neuron cell circuits is set such that there are i and j where a value of the number Ni of input signals received by the input units of the neuron cell circuits included in the i-th (i is a natural number equal to or greater than 1) neuron cell circuit group is smaller than a value of the number Nj of input signals received by the input units of the neuron cell circuits included in a j-th (j is a natural number equal to or greater than 1 where j>i) neuron cell circuit group.

21. The machine learning processing circuit according to claim 12, wherein
some of the plurality of neuron cell circuit are first-type neuron cell circuits each including the storage unit that is of a first type configured to hold output results of a first non-linear function corresponding to input values, use an output signal output by the adder unit, as an input value, and output an output result of the first non-linear function corresponding to the input value, and
at least one of the neuron cell circuits different from the first-type neuron cell circuits among the plurality of neuron cell circuit is a second-type neuron cell circuit including the storage unit that is of a second type configured to hold output results of a second non-linear function different from the first non-linear function and corresponding to input values, use an output signal output by the adder unit, as an input value, and output an output result of the second non-linear function corresponding to the input value.

22. The machine learning processing circuit according to claim 15, wherein
at least some of the neuron cell circuits included in the i-th (i is a natural number equal to or greater than 1) neuron cell circuit group are first-type neuron cell circuits each including the storage unit that is of a first type configured to hold output results of a first non-linear function corresponding to input values, use an output signal output by the adder unit, as an input value, and output an output result of the first non-linear function corresponding to the input value, and
at least one of the neuron cell circuits different from the first-type neuron cell circuits among the neuron cell circuits included in the i-th (i is a natural number equal to or greater than 1) neuron cell circuit group is a second-type neuron cell circuit including the storage unit that is of a second type configured to hold output results of a second non-linear function different from the first non-linear function and corresponding to input values, use an output signal output by the adder unit, as an input value, and output an output result of the second non-linear function corresponding to the input value.

23. The machine learning processing circuit according to claim 16, wherein
at least some of the neuron cell circuits included in the i-th (i is a natural number equal to or greater than 1) neuron cell circuit group are first-type neuron cell circuits each including the storage unit that is of a first type configured to hold output results of a first non-linear function corresponding to input values, use an output signal output by the adder unit, as an input value, and output an output result of the first non-linear function corresponding to the input value, and
at least one of the neuron cell circuits different from the first-type neuron cell circuits among the neuron cell circuits included in the i-th (i is a natural number equal to or greater than 1) neuron cell circuit group is a second-type neuron cell circuit including the storage unit that is of a second type configured to hold output results of a second non-linear function different from the first non-linear function and corresponding to input values, use an output signal output by the adder unit, as an input value, and output an output result of the second non-linear function corresponding to the input value.

24. The machine learning processing circuit according to claim 12, wherein
the machine learning processing circuit includes a die provided with the plurality of neuron cell circuit, and a chip is formed.

25. The machine learning processing circuit according to claim 12, further comprising:
shift register circuit units provided to correspond to the neuron cell circuits,
each of the shift register circuit units being configured to receive an input of data at every predetermined timing, hold data input in a predetermined number of times in the past, and output at least part of the held data to a neuron cell circuit in a later stage at the predetermined timing.

26. An information processing apparatus comprising:
a machine learning processing circuit including a plurality of neuron cell circuit, each of the plurality of neuron cell circuit including
an input unit that receives a plurality of input signals,
an adder unit that adds the input signals received by the input unit, and
a storage unit that holds output results of a non-linear function corresponding to input values, uses an output signal output by the adder unit, as an input value, and outputs an output result of the non-linear function corresponding to the input value.
